(19) United States
(12) Patent Application Publication
(10) Pub. No.: US 2008/0308491 A1
(43) Pub. Date: Dec. 18, 2008

(54) Electrolyte

(76) Inventor: Thomas Haring, Stuttgart (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 12/066,951

(22) PCT Filed: Sep. 14, 2006
(86) PCT No.: PCT/DE06/01646

§ 371 Date: Jul. 31, 2008

(30) Foreign Application Priority Data
Sep. 14, 2005 (DE) 10 2005 044 042.8

(51) Int. Cl. C08K 5/5353; B01D 71/72; H01M 8/10

(52) U.S. Cl. 210/500.21; 429/33; 524/124

(57) ABSTRACT

The invention relates to membranes made from polybenzimidazole, doped with low-molecular-weight phosphonic acids and optionally with phosphoric acids. Membranes, doped with phosphoric acid and an aminophosphonic acid have an increased proton conductivity with relation to doping with only one of the components.

### STATE-OF-THE-ART

Membranes from polybenzimidazole (PBI) containing phosphoric acid (PA) are used as polymer electrolyte fuel cell membranes (PEM). Thereby the PA is immobilised in the PBI membrane.

The following invention relates to the preparation of an electrolyte for this and other applications.

### DESCRIPTION

This entirely novel and surprising interaction has been discovered. Amino trismethylene-phosphonic acid (ATMP) is a low molecular aminophosphonic acid. A membrane made from PBI containing ATMP and PA has higher proton conductivity as compared with a PBI membrane containing only PA or a PBI membrane containing only ATMP. The latter is valid especially at temperatures above 130° C. Is ATMP immobilised into a PBI membrane (example 1), no or only a low proton conductivity can be measured above 130° C. In comparison a PBI membrane with PA (example 2) has at the same temperature clearly higher proton conductivity.

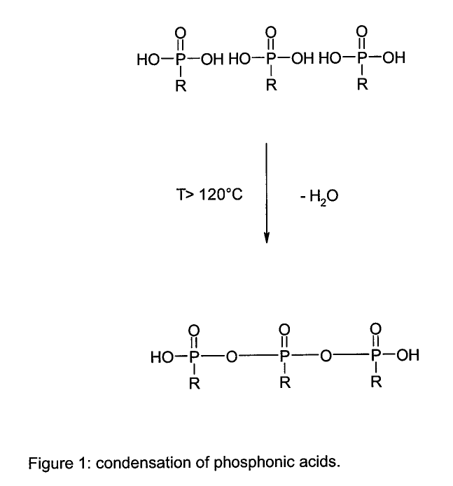

This is as expected, as ATMP condenses at temperatures above 130° C. and releases water (FIG. 1). Due to the release of water the phosphonic acids lose their acid functionality and can no longer be used as electrolyte.

A PBI membrane made as described in example 4 contains ATMP as well as PA. This membrane has higher proton conductivity as the membranes from example 1 and 2. This is completely surprising and could not be expected. Particularly surprising is the higher proton conductivity for temperatures above 120° C. In the temperature range up to 200° C. the proton conductivity is clearly above comparable membranes containing only PBI or PA.

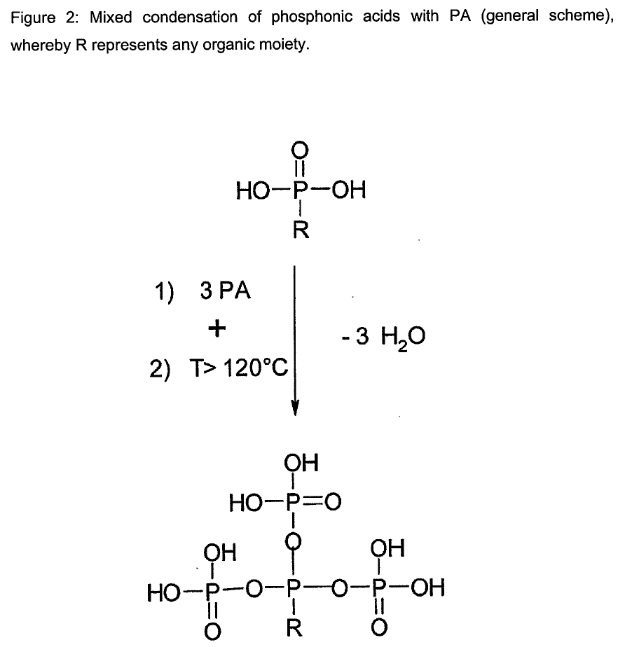

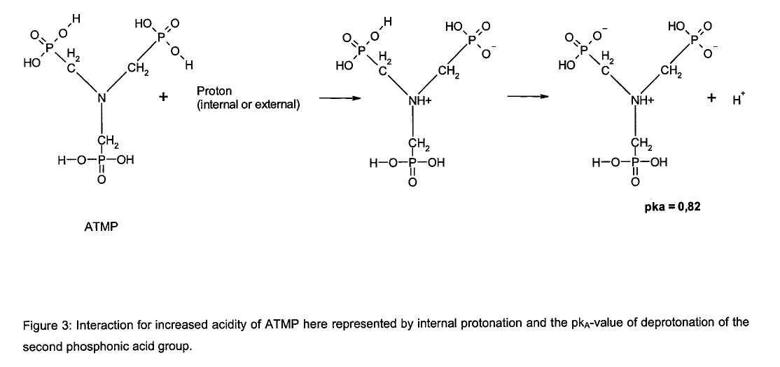

Two mechanisms have been identified, which might be responsible for this. The first mechanism is a mixed condensation reaction between ATMP and PA (FIG. 2) and the second mechanism is an amplifying effect caused by protonated nitrogen in the ATMP molecule (FIG. 3). By the second interaction the acidity of the released protons is increased. The Brönstedt acid for the protonation of the nitrogen can be from the same molecule e.g. a phosphonic acid or from a different molecule. Both is possible and there are different applications depending on the proton source which is used.

The order of the atoms in the order of bonds N—C—P is determining the increase of the acidity. Is C a CH₂-group, the following general formula is obtained R₂N—CH₂—PO₃H₂, whereby R is independently from another an alkyl-, aryl- heteroaryl-moiety, a carbon atom substituted at will or hydrogen. R can carry any functional groups. As examples without restricting the scope are mentioned phosphonic acids, sulfonic acids, carbonic acids, hydroxyl-, nitro- and amino groups. To increase the acidity or the stability R can also contain fluorine. In the case of ATMP both moieties R are identical and R is —CH₂—PO₃H₂. When the nitrogen is protonated, R₂NH⁺—CH₂—PO₃H₂ is obtained and the acidity of the phosphonic acid moiety is strongly increased. This translates into higher proton conductivity. Below the condensation temperature the proton conductivity of the doped membrane is higher as compared to doping with phosphoric acid. FIG. 3 shows the protonation of ATMP.

In the examples polybenzimidazole from chemicals supplier Aldrich was used. A 10% solution of PBI in DMAc was used to manufacture the starting membrane. The solution was casted on a glass plate and the solvent evaporated in the drying oven. A membrane of PBI is obtained.

### EXAMPLES

### 1) Immobilisation of ATMP in a PBI Membrane

A membrane of PBI (10×10 cm²) with a thickness of 60μ is soaked in a 50% by weight solution of ATMP in water. The solution is left for 24 h at 60-80° C. in the oven. Then the membrane is removed and weighed after the surface is dried with pulp. The membrane is dried in the drying oven at 80-110° C. and again weighed. It contains now 20% by weight ATMP.

The uptake of ATMP depends on treatment time, concentration and temperature of the ATMP solution. Concentrations above 40% ATMP in PBI are obtained by repeated treating and drying. By drying the membrane the water is removed.

The uptake of ATMP or another aminophosphonic acid is further increased by adding an aprotic solvent to the aqueous aminophosphonic acid solution. The aprotic solvent or any mixture of aprotic solvents serves to swell the PBI membrane. Examples for such solvents are NMP, DMAC, sulfolane or DMSO. The enumeration is not restricting. Preferred is DMSO, because it does not contain basic nitrogen. The only prerequisite for the solvent is to increase the swelling of PBI. Acetone for example is less suitable as it does swell PBI membrane only marginally. A solution of 100% NMP is also not suitable, as the aminophosphonic acids do not dissolve in concentrated aprotic solvents any more. The chosen proportion between water and aprotic solvent depends on the chosen doping level.

The use of additional solvents to water is particularly preferred, if the aminophosphonic acid has a higher molecular weight. An example is diethylene-triamino-pentamethylen-phosphonic acid (DTPMP). From an aqueous solution only 2-4% DTPMP is up taken by PBI. If the solvent is 50-70% NMP or DMSO in water, more than 6% DTPMP can be incorporated in the PBI membrane.

### 2) Immobilisation of PA in a PBI Membrane

A membrane of PBI (10×10 cm²) with a thickness of 60μ is soaked in a 50% by weight solution of PA in water. The solution is left for 24 h at 80° C. in the oven. The membrane is dried as in example 1.

### 3) Immobilisation of PA and ATMP in a PBI Membrane

A membrane of PBI (10×10 cm²) with a thickness of 60μ is soaked in an aqueous solution of ATMP and PA. The solution contains 25% by weight ATMP and 25% by weight PA. The solution is left for 24 h at 80° C. in the oven. The membrane is dried as in example 1.

PA is used instead of an aprotic solvent. This treatment has the advantage that the PA is incorporated simultaneously to the aminophosphonic acid into the membrane.

### 4) Immobilisation of PA and ATMP in a PBI Membrane

A membrane of PBI (10×10 cm²) with a thickness of 60μ is soaked in an aqueous solution of ATMP and PA. The solution contains 25% by weight ATMP and 25% by weight PA. The solution is left for 24 h at 80° C. in the oven. The membrane is dried at 130° C. and then again soaked in the solution of ATMP and PA.

By the repeated treatment of the membrane water is removed and the doping content with ATMP and PA is increased.

1. PBI membrane characterised in that it contains any mixture of one or more low molecular phosphonic acids.

2. PBI membrane characterised in that it contains ATMP and phosphoric acid.

3. Process for doping of PBI characterised in that a PBI membrane is soaked in subsequent steps or independently from another in a) a solution of diluted or concentrated phosphoric acid and/or b) a solution of aminophosphonic acid in water or phosphoric acid.

4. PBI membrane containing an immobilised aminophosphonic acid, phosphoric acid and at least another if necessary functionalised polymer.

5. Claim 4 characterised in that the additional polymer carries functional groups.

6. Claim 5 characterised in that the additional polymer is a sulfonated polymer and that the proportion of the sulfonated polymer can be up to 90%.

7. Claim 6 characterised in that the sulfonated polymer is present in the blend in the salt form during the doping with aminophosphonic acid, whereby the sodium salt form is preferred.

8. Claim 7 characterised in that the acid base blend is not doped with phosphoric acid but only with one or more aminophosphonic acids.

9. Membrane according to one of the previous claims characterised in that the amount of aminophosphonic acids can be up to 80% by weight.

10. Use of membranes according to claims 1 to 9 as membrane in membrane processes.

11. Use of membranes according to one of the previous claims especially in membrane fuel cells, pervaporation membranes, dialysis membranes, reverse osmosis membranes, nanofiltration membranes ad ultrafiltration membranes.
